(19) United States
(12) Patent Application Publication
(10) Pub. No.: US 2021/0194916 A1
(43) Pub. Date: Jun. 24, 2021

(54) METHODS FOR INVENTORYING NETWORK HOSTS AND DEVICES THEREOF

(71) Applicant: Infinite Group, Inc., Pittsford, NY (US)

(72) Inventors: Brian A. Drake, Rochester, NY (US); Andrew T. Hoyen, Fairport, NY (US); James A. VIilla, Rochester, NY (US)

(21) Appl. No.: 17/133,757

(22) Filed: Dec. 24, 2020

Related U.S. Application Data
(60) Provisional application No. 62/953,273, filed on Dec. 24, 2019.

(51) Int. Cl. H04L 29/06; G06N 20/00; H04L 12/26

(52) U.S. Cl. CPC H04L 63/1433; H04L 43/18; G06N 20/00

(57) ABSTRACT

Methods, network scanning devices, and non-transitory machine readable media that more effectively and efficiently inventory network hosts to facilitate improved vulnerability scanning are illustrated. With this technology, at least one of a plurality of tests is identified based on an application of a model to one or more characteristics of a network following detection of a host device in a segment of the network. The identified at least one of the plurality of tests is applied on the detected host device to obtain at least one result. The at least one result includes identifiable information for the detected host device. A determination is then made when a classification threshold has been satisfied for the detected host device based at least in part on the identifiable information. A host inventory database is updated to include at least the identifiable information, when the determination indicates the classification threshold has been satisfied.

This application claims the benefit of U.S. Provisional Patent Application Ser. No. 62/953,273, filed Dec. 24, 2019, which is hereby incorporated by reference in its entirety.

### FIELD

This technology generally relates to computer network security and, more particularly, to methods and devices for more effectively and efficiently inventorying network hosts to facilitate improved vulnerability scanning.

### BACKGROUND

Network assessments can involve processes to protect a network environment from vulnerabilities that may be present on host devices communicating via the network. In order to conduct vulnerability scans, the network must first be scanned to identify and inventory the host devices currently connected to the network, including those host devices that may be relatively transient or may have disconnected and subsequently rejoined the network. The inventorying requires that the host devices are uniquely identified.

In some deployments, a network scanning device coupled to a server or other device on a network may utilize address resolution protocol (ARP) packets to discover a link layer address, such as a media access control (MAC) address, for each of the connected host devices. The network scanning device can then populate a database, for example, with entries that correlate Internet protocol (IP) addresses for the host devices with the MAC addresses that uniquely identify the host devices. The contents of the database can then be used by the network scanning device, or a network assessment device that is separately deployed, for example, to perform the vulnerability scanning of the host devices on the network.

However, when network traffic crosses a boundary into a network segment, such as a subnet, virtual local area network (VLAN), or virtual private network (VPN), for example, the uniquely identifying information (e.g., MAC address) is stripped away. Accordingly, the mapping of the uniquely identifying information with the IP address resides only on a network control device (e.g., a router or managed switch) that performs a translation required to appropriately steer the network traffic, and is not otherwise propagated or communicated within the network.

Without the transmission of the uniquely identifying information, it is difficult for network scanning devices, which are not network control devices, to inventory host devices that are coupled to a network via a network segment. Accordingly, host inventory databases often lack the accuracy necessary to facilitate effective vulnerability scanning, particularly across network segments, requiring the deployment of agents configured to uniquely identify host devices, and/or perform the vulnerability scan, in every segment or on every host device, which is undesirable.

### SUMMARY

A method for inventorying network hosts includes identifying, by a network scanning device, at least one of a plurality of tests is identified based on an application of a model to one or more characteristics of a network following detection of a host device in a segment of the network. The identified at least one of the tests is applied, by the network scanning device, on the detected host device to obtain at least one result. The result includes identifiable information for the detected host device. A determination is made, by the network scanning device, on whether a classification threshold has been satisfied for the detected host device based at least in part on the identifiable information. A host inventory database is updated, by the network scanning device, to include at least the identifiable information, when the determination indicates the classification threshold has been satisfied.

A network scanning device includes memory including programmed instructions stored thereon and one or more processors configured to execute the stored programmed instructions to identify at least one of a plurality of tests based on an application of a model to one or more characteristics of a network following detection of a host device in a segment of the network. The identified at least one of the tests is applied on the detected host device to obtain at least one result. The result includes identifiable information for the detected host device. A determination is made on whether a classification threshold has been satisfied for the detected host device based at least in part on the identifiable information. A host inventory database is updated to include at least the identifiable information, when the determination indicates the classification threshold has been satisfied.

A non-transitory machine readable medium has stored thereon instructions for inventorying network hosts that include executable code that, when executed by one or more processors, causes the processors to identify at least one of a plurality of tests based on an application of a model to one or more characteristics of a network following detection of a host device in a segment of the network. The identified at least one of the tests is applied on the detected host device to obtain at least one result. The result includes identifiable information for the detected host device. A determination is made on whether a classification threshold has been satisfied for the detected host device based at least in part on the identifiable information. A host inventory database is updated to include at least the identifiable information, when the determination indicates the classification threshold has been satisfied.

This technology has a number of associated advantages including providing methods, network scanning device, and non-transitory machine readable media, that more effectively and efficiently inventory network hosts to facilitate improved vulnerability scanning. Examples of this technology advantageously inventory host devices across network segments without requiring agents to be deployed on the segments or the host devices.

By utilizing network characteristic(s) and/or test result(s) to select, prioritize, and rank tests from a test database, a machine learning model in examples of this technology advantageously is trained to facilitate application of an optimized subset of tests in order to improve the speed with which host devices can be uniquely identified and inventoried. The ability to establish an accurate inventory of connected network hosts is critical to effective vulnerability scanning and improving network security, among other application.

### BRIEF DESCRIPTION OF THE DRAWINGS

FIG. 1 is a block diagram of an exemplary network environment with a network scanning device coupled to interact with a network assessment device;

FIG. 2 is a block diagram of an exemplary network scanning device;

FIG. 3 is a flowchart of an exemplary method for obtaining identifiable information used to uniquely identify and inventory network hosts across network segments;

FIG. 4 is a hierarchy of exemplary results of an application of a machine learning model in several iterations relating to identifying a webserver via secure socket layer (SSL) certificate; and

FIG. 5 is a hierarchy of exemplary results of an application of a machine learning model in several iterations relating to identifying a Windows' personal computer (PC) via network basic input/output system (NetBIOS).

### DETAILED DESCRIPTION

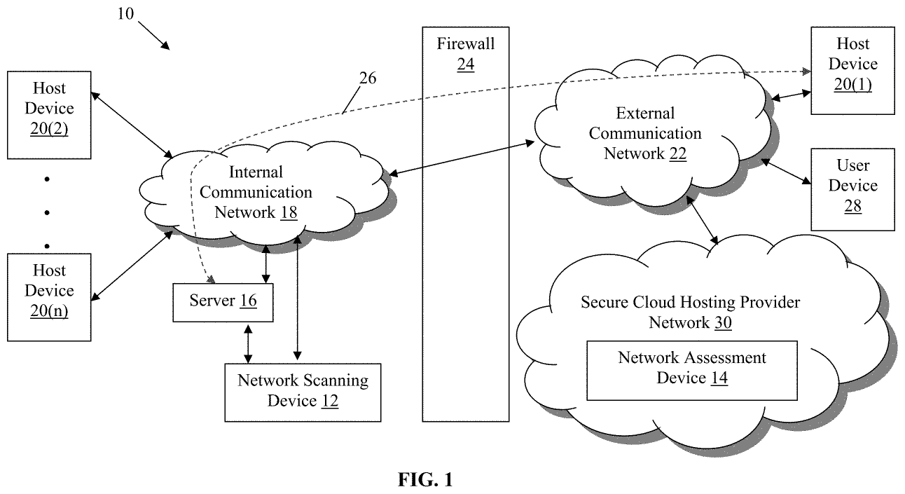

An example of a network environment 10 with a network scanning device 12 coupled to interact with a network assessment device 14 is illustrated in FIG. 1. In this particular example, the network scanning device 10 is coupled to a server 16 and an internal communication network 18 that includes the server 16. The internal communication network 18 also hosts a plurality of host devices 20(2)-20(n). The internal communication network 18 is coupled to an external communication network 22 with a firewall 24 disposed between the internal and external communication networks 18 and 22, respectively. The external communication network 22 hosts another host device 20(1) that is coupled to the server 16 via a network segment, which in this example is a virtual private network (VPN) connection 26, although the host device 20(1) can be coupled via other types of network segments in other examples. The external communication network 22 further hosts a user device 28 that is configured to interface with the network assessment device 12 hosted by a secure cloud hosting provider network 30 that is coupled to the external communication network 22. The network environment 10 also could have other types and/or numbers of other systems, devices, components, and/or other elements in other configurations in other examples, such as one or more routers or switches, for example, which are well known in the art and will not be described herein. This technology provides a number of advantages including providing methods, network scanning devices, and non-transitory machine readable media that more effectively and efficiently inventory network hosts across network segments to facilitate improved vulnerability scanning and network security.

In this particular example, the network assessment device 14 with the network scanning device 12 may perform a number of functions and/or other actions as illustrated and described by way of the examples herein including inventorying the host devices 20(1)-20(n) and conducting vulnerability scans of the host devices 20(1)-20(n), although the network assessment device 14 with the network scanning device 12 may perform other types and/or numbers of other operations, functions and/or actions.

Additionally, the network assessment device 14 and the network scanning device 12 may have other configurations, such as having the network assessment device 14 in the internal communication network 18, in the external communication network 22 as shown in this example, and/or incorporated within the network scanning device 12. Further, in this particular example, the network assessment device 14 is an external vulnerability scanner in a cloud secure hosting provider network 30 hosted by a secure cloud hosting provider that uses inventory information obtained by the network scanning device 12, although other configurations can also be used.

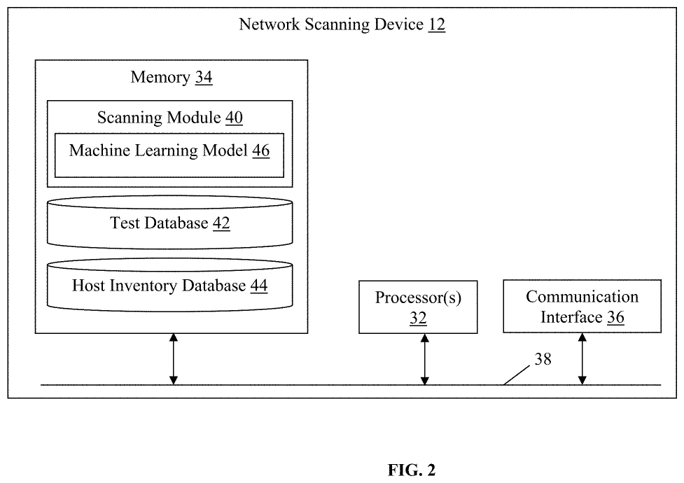

Referring more specifically to FIGS. 1-2, in this particular example the network scanning device 12 may include processor(s) 32, a memory 34, and a communication interface 36, which are coupled together by a bus 38 or other communication link, although the network scanning device 12 can include other types and/or numbers of systems, devices, components and/or other elements in other configurations. The processor(s) 32 of the network scanning device 12 may execute programmed instructions stored in the memory 34 of the network scanning device for any number of the functions and other operations illustrated and described by way of the examples herein. The processor(s) 32 may include one or more central processing units (CPUs) or general purpose processors with one or more processing cores, for example, although other types of processor(s) can also be used.

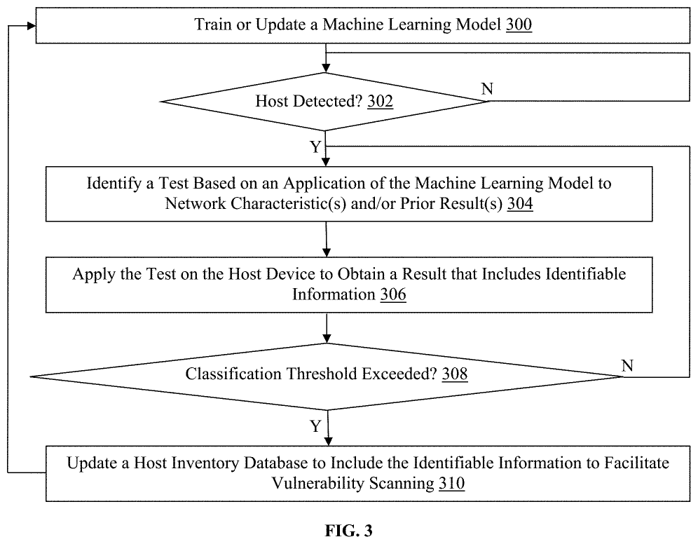

The memory 34 of the network scanning device stores these programmed instructions for one or more aspects of the present technology as described and illustrated herein, although some or all of the programmed instructions could be stored elsewhere. A variety of different types of memory storage devices, such as random access memory (RAM), read only memory (ROM), solid state drives (SSDs), flash memory, or other computer or machine readable medium which is read from and written to by a magnetic, optical, or other reading and writing system that is coupled to the processor(s) 32, can be used for the memory 34. The memory 34 of can store application(s) that can include computer executable instructions that, when executed by the network scanning device 12, cause the network scanning device 12 to perform actions, such as to detect and effectively inventory the host devices 20(1)-20(n), for example, and to perform other actions, as described and illustrated by way of the examples below with reference to FIGS. 3-5.

The application(s) can be implemented as modules or components of other applications. Further, the application(s) can be implemented as operating system extensions, modules, plugins, or the like. The memory 34 in this example includes a scanning module 40, a test database 42, and a host inventory database 44. The scanning module 40 is configured to detect the host devices 20(1)-20(n), select tests from the test database 42 to execute on one or more of the host devices 20(1)-20(n), and obtain results of the test execution that include identifiable information used to populate the host inventory database 44. The scanning module 40 in this example may include a machine learning model 46 that is trained and updated to facilitate identification of the tests according to a selection and ranking that uses network characteristics to optimize the test identification and reduce the time required to uniquely identify one or more of the host devices 20(1)-20(n) beyond a classification threshold.

The communication interface 36 of the network scanning device 12 operatively couples and communicates between the network scanning device 12 and the network assessment device 14, the host devices 20(1)-20(n), the server 16, and/or the user device 28 via one or more of the internal or external communication networks 18 and 22, respectively, although other types and/or numbers of connections and/or other communication networks or systems with other types and/or numbers of connections and configurations to other devices and elements can also be used.

The network assessment device 14 in this example can be configured to utilize the host inventory database 44 to initiate vulnerability scanning of the host devices 20(1)-20(n), and/or to provide other network security services, for example. In this particular example, the network assessment device 14 is located in a secure cloud hosting provider network 30 in a cloud environment coupled to the external communication network 22. The network assessment device 14 acts as an external scanner interacting with the network scanning device 12 via one or more of the internal and/or external communication networks 18 and 22, respectively, although the network assessment device 12 could be in other locations and/or may have other configurations, such as being integrated with the network scanning device 12 by way of example only.

The network assessment device 14 in this example includes processor(s), a memory, and a communication interface, which are coupled together by a bus or other communication link, although the network assessment device 14 can include other types and/or numbers of systems, devices, components, and/or elements in other configurations. The processor(s) of the network assessment device 14 may execute programmed instructions stored in the memory for operations, functions, and/or other actions illustrated and described by way of the examples herein. The processor(s) of the network assessment device 14 may include one or more CPUs or processing cores, for example, although other types of processor(s) can also be used.

The memory of the network assessment device 14 may store these programmed instructions for one or more aspects of the present technology as described and illustrated by way of the examples herein, although some or all of the programmed instructions could be stored elsewhere. A variety of different types of memory storage devices, such as RAM, ROM), solid state drives, flash memory, or other computer readable medium which is read from and written to by a magnetic, optical, or other reading and writing system that is coupled to the processor(s), can be used for the memory. The memory of the network assessment device 14 can store application(s) that can include computer executable instructions that, when executed by the network assessment device 14, cause the network assessment device 14 to perform functions and/or other actions and interact with network scanning device 12. The application(s) can be implemented as modules or components of other applications. Further, the application(s) can be implemented as operating system extensions, modules, plugins, or the like.

The host devices 20(1)-20(n) in this example are in or are coupled to the internal communication network 18 and may include any type of computing device, such as mobile computing devices, desktop computing devices, laptop computing devices, tablet computing devices, virtual machines (including cloud-based computers), or the like, although other types and/or numbers of systems, device, components or other elements with an Internet protocol (IP) address in the internal and/or external communication network 18 and 20, respectively, may be used. The host devices 20(1)-20(n) in this example may include processor(s), a memory, and a communication interface, which are coupled together by a bus or other communication link, although other numbers and types of network devices could be used. The host devices 20(1)-20(n) may further include a display device, such as a display screen or touchscreen, and/or an input device, such as a keyboard for example. The host devices 20(1)-20(n) may by way of example run interface applications, such as standard web browsers or standalone client applications, that may provide an interface to make requests for, and receive content stored on, for example, the server 16 via one or more of the internal or external communication networks 18 and 20, respectively.

The server 16 in the internal communication network 18 in this example may include processor(s), a memory, and a communication interface which are coupled together by a bus or other communication link, although other types and/or numbers of systems, devices, components and/or other elements may be used. Various applications may be operating on the server 16 and transmitting data (e.g., files or web pages) to one or more of the host devices 20(1)-20(n) by way of example only. The server 16 may be hardware or software or may represent a system with multiple servers and/or databases in a pool and may also be in a cloud environment. Further, in this example, the server 16 provides an Ethernet port for coupling an Ethernet cable to another Ethernet port of the network scanning device 12 (e.g., of the communication interface 36), although the network scanning device 12 can be coupled to the server 16 in other manners and/or to other systems and/or devices.

The user device 28, such as for a customer or reseller of the network scanning device 12 and/or network assessment device 14, by way of example only, may include processor(s), a memory, a display device, an input device and a communication interface, which are coupled together by a bus or other communication link, although other types and/or numbers of systems, devices, components and/or other elements may be used. The user device 28 in this example may interact with the network assessment device 14 to obtain assessments (e.g., vulnerability scan results) and other information via provided user interface(s).

By way of example only, one or more of the internal and/or external communication networks 18 and 22, respectively may include local area network(s) (LAN(s)) or wide area network(s) (WAN(s)), and can use transmission control protocol (TCP) over IP (TCP/IP) over Ethernet and industry-standard protocols, although other types and/or numbers of protocols and/or communication networks can be used. The internal and/or external communication networks 18 and 22, respectively, in this example can employ any suitable interface mechanisms and network communication technologies including, for example, Ethernet-based Packet Data Networks (PDNs) and the like.

Although an example of a network environment 10 with a network scanning device 12, a network assessment device 14, host devices 20(1)-20(n), a server 16, a secure cloud hosting provider network 30, and a user device 28, which may be coupled together by one or more direct links, such as via an Ethernet connection, and/or by one or more of the internal or external communication networks 18 and 22, respectively, are described and illustrated herein, other types and/or numbers of systems, devices, components, and/or elements in other configurations may be used. It is to be understood that the systems of the examples described herein are for example of purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only, wireless traffic networks, cellular traffic networks, packet data networks (PDNs), the Internet, intranets, and combinations thereof.

The examples may also be embodied as one or more non-transitory machine readable media, such as the memory 34 of the network scanning device 12, having instructions stored thereon for aspect(s) of the present technology as described and illustrated by way of the examples herein. The instructions in some examples include executable code that, when executed by processor(s), such as the processor(s) 32 of the network scanning device 12, cause the processor(s) to carry out steps necessary to implement the methods of the examples of this technology that are described and illustrated herein.

An exemplary method for inventorying network hosts will now be described with reference to FIGS. 3-5. In one example, an Ethernet cable may be plugged into an Ethernet port of the network scanning device 12 and another Ethernet port of the server 16 to couple the network scanning device 12 into the internal communication network 18, although the network scanning device 12 may be coupled in other manners and/or to another system, device, and/or host. Upon activation, and optionally based on instructions received from the network assessment device 14 via the internal and external communication networks 18 and 22, respectively, the network scanning device 12 begins conducting an inventory for all systems, devices, and/or hosts with an IP address on the internal communication network 18 on a regular basis.

Accordingly, the network scanning device 12 may begin scanning to individually identify and harvest information on any systems, devices or hosts, such as computers, phones, televisions or any device that accept an IP address by way of example only, currently on the internal communication network 18 in this example. Once engaged, the network scanning device 12 may continue this scan to individually identify and harvest information to capture any devices that enter or leave the internal and/or external communication networks 18 and 22, respectively.

In one example, the network scanning device 12 may transmit address resolution protocol (ARP) packets to all addresses for systems, devices, and/or hosts in, for example, a subnet or other defined network, such as for a particular organization or other entity on the internal communication network 18, although the ARP packets could be sent to systems, devices, and/or hosts for another defined network which includes both the internal and/or external communication networks 18 and 22, respectively.

The network scanning device 12 receives all the responses back to this transmission which now links the media access control (MAC) addresses to IP addresses, which can be stored in the host inventory database 44 or transmitted to the network assessment device 14 for storage, for example. An exemplary method for inventorying network hosts coupled directly to, and communicating within the boundaries of the internal communication network 18 is described and illustrated in more detail in U.S. patent application Ser. No. 15/600,297, filed on May 19, 2017 and entitled “NETWORK ASSESSMENT SYSTEMS AND METHODS THEREOF,” which is incorporated by reference herein in its entirety.

However, ARP messages are encapsulated by a link layer protocol communicated within the boundaries of a single network, such as the internal communication network 18. Accordingly, while some hosts, such as the host device 20(1) coupled directly to the external communication network 22, may have an IP address that is detected by the network scanning device 12, the network scanning device 12 will not be able to inventory such hosts utilizing ARP packets, and will not therefore be able to obtain the uniquely identifiable information in the form of a MAC address.

More specifically, in this example the host device 20(1) coupled directly to the external communication network 22 is effectively coupled to the internal communication network 18 via a network segment, which in this example is the VPN connection 26, although the network segment can be another types of segment such as a subnet or virtual local area networks (VLANs), for example. Since the network traffic originating with the host device 20(1) crosses a network segment boundary in which link layer information is stripped away, the network scanning device 12 may only be able to communicate with the host device 20(1) over the network layer and above. Examples of this technology are advantageously able to implement and provide network inventorying and security across network segments and through the network scanning device 12 while avoiding the need to load any type of agent on any of the systems, devices, or hosts (e.g., host devices 20(1)-20(n)).

Referring more specifically to FIG. 3, a flowchart of an exemplary method for obtaining identifiable information used to uniquely identify and inventory network hosts across network segments is illustrated. In step 300 in this example, the network scanning device 12 may train or update the machine learning model 46 for inventorying network hosts across network segments to facilitate improved vulnerability scanning and network security, although other examples of this technology may operate as illustrated and described with the examples herein without machine learning. In this example, the network scanning device 12 trains the machine learning model 46 prior to deployment in a live environment, and updates the machine learning model 46 following subsequent iterations of steps 302-310.

The machine learning model 46 can be trained using a sample dataset of input data having known output data. The input data can include network characteristic(s) and/or prior test result(s) and the output data can include an optimal or minimal set of test(s) selected from the test database 42 that are collectively capable of yielding identifiable information sufficient to identify a host beyond a classification threshold. Subsequent to a live deployment, the learning or updating of the machine learning model 46 can be applied on an edge computing device in the network environment, such as the network scanning device 12, or in a cloud network with access to a relatively large learning dataset, such as the secure cloud hosting provider network 30 with the network assessment device 14.

In step 302, the network scanning device 12 determines whether a new or newly joined host, such as the host device 20(1) having a VPN connection 26 with the server 16, has been detected. The detection can result from a background and/or periodic sniffing process for example, although any method of detecting the host device 20(1) (e.g., a new IP address of the host device 20(1)), can also be used. If the network scanning device 12 determines that a host device has not been detected, then the network scanning device 12 returns to step 302 and the network scanning device 12 effectively waits to detect a host device. However, if the network scanning device 12 determines that a host has been detected, then the Yes branch is taken to step 304.

In step 304, the network scanning device 12 identifies at least one test from the test database 42 based on application of the machine learning model 46 to network characteristic(s) and/or prior test result(s) for the detected host device 20(1), although other approaches for identifying at least one test based on the network characteristic(s) and/or prior test result(s) for the detected host device 20(1) may be used. In an initial iteration, the network scanning device 12 may not have any prior test results, and will instead utilize only network characteristic(s). The network characteristic(s) can include a protocol used by the host device 20(1) to provide a service or to communicate with another host device 20(2)-20(n), initial inventory discovery results, network factors such as address turnover and dynamic host configuration protocol (DHCP) lease times, previous addressed host, analogous or neighbor host results, and/or environment homogeny, although other types of network characteristics can also be used in other examples.

By way of example only, a host detected in a network comprising primarily Windows based operating systems may favor server message block (SMB) or network basic input/output system (NetBIOS) tests if corresponding ports are found to be open or responsive on the host. In another example, a host may be scanned using the same test as the previous host at the same IP address if there are fewer hosts than available DHCP addresses, which increases the likelihood that a previously discovered host is reassigned the same address. By using the same test as used previously, the amount of testing required to uniquely identify the detected host is advantageously reduced in this example.

In step 306, the network scanning device 12 applies the identified test(s) on the detected host device 20(1) to obtain a result that includes identifiable information. In this example, the tests target unique attributes about a particular host and are repeatable and predictable tests that return a result and can be completed in a relatively short period of time. The tests in the test database 42 advantageously leverage existing protocols and native system tools and libraries. In one particular example, open secure socket layer (OpenSSL) command line tools can be used to calculate a signature for a webserver detected host that utilizes secure hypertext transfer protocol (HTTPS) to secure communications. The signature is identifiable information that can be used to uniquely identify the detected host. Many other types of tests can be used in other examples.

In step 308, the network scanning device 12 generates a classification value and determines whether the classification value satisfies a classification threshold. The classification threshold is a configurable value representing the likelihood that the obtained set of identifiable information for a particular detected host is collectively capable of uniquely identifying the detected host. Since not all protocols require uniquely identifiable information, the combination of several non-unique values, optionally weighted to determine the classification value, can be used to identify a detected host within the classification threshold.

If the network scanning device 12 determines that the classification threshold has not been satisfied, then the No branch is taken back to step 304 in this example, and steps 304-308 are repeated in a subsequent iteration. In the subsequent iteration, the network scanning device 12 again identifies test(s) by applying the machine learning model 46 optionally using the result obtained in the prior iteration of step 306 to inform the test selection in the subsequent iteration.

In other examples, the network scanning device 12 can obtain additional identifying information from third party sources either subsequent to a failure to satisfy the classification threshold and/or before determining the classification value and/or testing the classification value against the classification threshold. The third party sources in some examples include domain directory services, internal domain name resolution, service management platforms, or asset tracking databases, although other types of third party sources of identifying information can also be used.

The additional identifying information can be combined with the test results to increase identification accuracy and speed. Optionally, registered additional identifying information can be confirmed against live hosts to prevent misidentification due to updates or changes to the host or connected networks. In some examples, if the classification threshold is still not satisfied in view of the additional identifying information, then steps 304-306 are repeated. Otherwise, if the classification threshold is satisfied, then the Yes branch can be taken from step 308 to step 310, as described in more detail below.

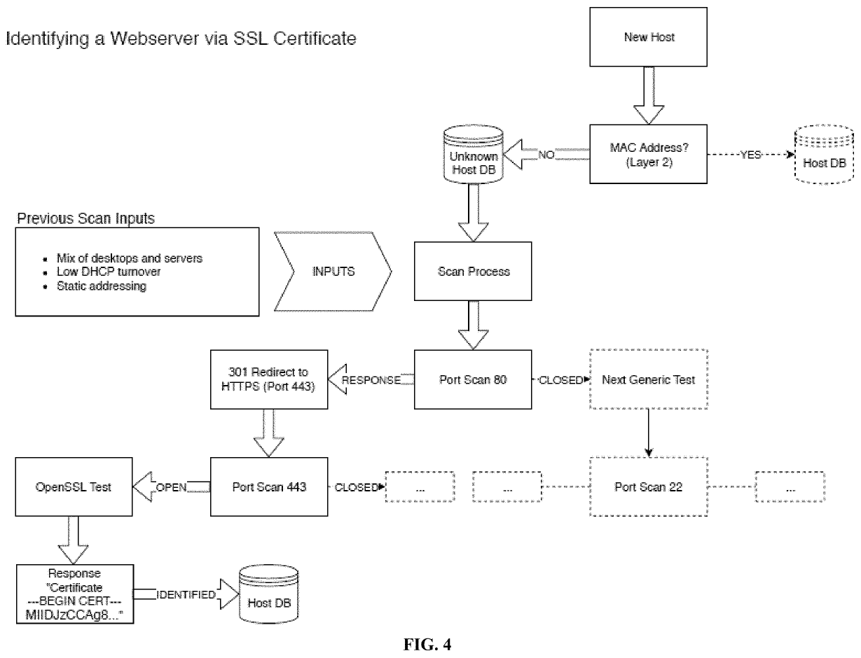

Referring more specifically to FIG. 4, a hierarchy of exemplary results of the application of the machine learning model 46 in several iterations relating to identifying a webserver via SSL certificate is illustrated. In this particular example, the network scanning device 12 detects a new host and determines that it is unable to obtain a MAC address for the new host. Accordingly, the network scanning device 12 applies the machine learning model 46 to network characteristics that have been obtained via prior scans of the networks, including an indication that the network includes a mix of desktops and servers, the network has low DHCP turnover, and the network has static addressing.

Based on the network characteristics, the machine learning model 46 in a first iteration identifies a port scan test for port 80. As a result of the port scan test for port 80, identifiable information is obtained indicating that port 80 is open and that a 301 redirect response to port 443 was received, which is insufficient to satisfy the classification threshold or uniquely identify the host.

Accordingly, the obtained result is fed into the machine learning algorithm 46 in a subsequent iteration, which then identifies a test requiring a port scan test for port 443. As a result of the subsequent port scan test for port 443, identifiable information is obtained indicating that port 443 is open and that an SSL certificate was received that includes a signature. Since the signature is sufficient to satisfy the classification threshold, and uniquely identifies the webserver host, the network scanning device 12 inserts an entry into the host inventory database 44 that includes the signature and an IP address or generated unique identifier for the webserver host.

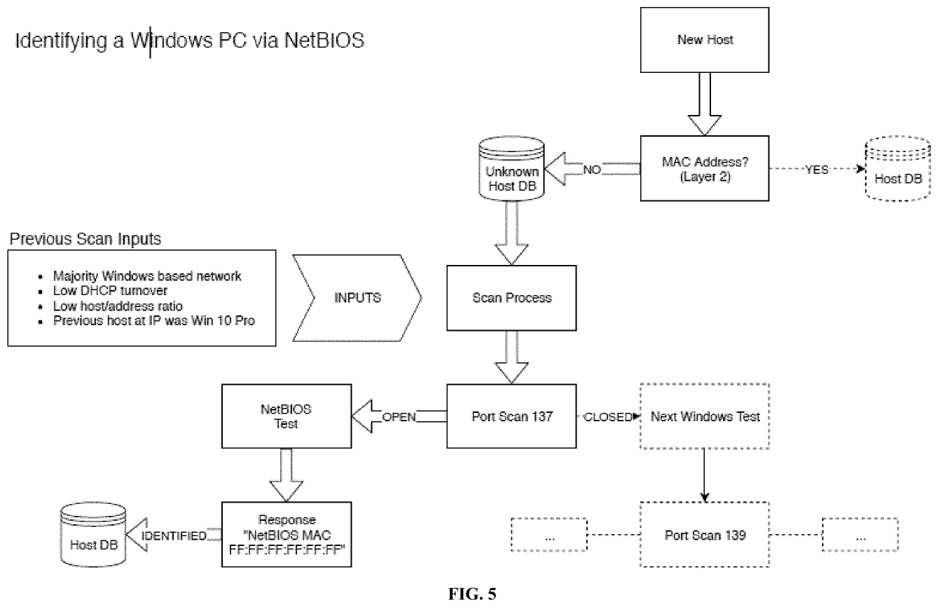

Referring more specifically to FIG. 5, a hierarchy of exemplary results of the application of the machine learning model 46 in several iterations relating to identifying a Windows™ PC via NetBIOS is illustrated. In this example, the network scanning device 12 again detects a new host and determines that it is unable to obtain a MAC address for the new host. Accordingly, the network scanning device 12 applies the machine learning model 46 to network characteristics that have been obtained via prior scans of the network, including an indication that the network has a majority of Windows™ hosts, low DHCP turnover, low host/address ratio, and the previous host at the IP address was executing a Windows 10 Pro™ operating system.

Based on the network characteristics, the machine learning model 46 in a first iteration identifies a port scan test for port 137. As a result of the port scan test for port 137, identifiable information is obtained indicating that port 137 is open, which is insufficient to satisfy the classification threshold or uniquely identify the host. The obtained result is then fed into the machine learning algorithm 46 in a subsequent iteration, which then identifies a NetBIOS test. As a result of the subsequent NetBIOS test, identifiable information is obtained including a NetBIOS MAC address, which is sufficient to satisfy the classification threshold and uniquely identifies the host. The network scanning device 12 then inserts an entry into the host inventory database 44 that includes the NetBIOS MAC address and an IP address or generated unique identifier for the host.

Accordingly, the network scanning device 12 effectively takes a particular path through the machine learning model 46 based on input network characteristic(s) and/or prior tests result(s) in order to identify the test(s) to be subsequently applied in order to arrive at sufficient identifiable information for a detected host in order to satisfy the classification threshold. Referring back to FIG. 3, if the network scanning device 12 determines in step 308 that the classification threshold has been satisfied, then the Yes branch is taken to step 310.

In step 310, the network scanning device 12 updates the host inventory database 44 to include identifiable information for the detected host device 20(1), optionally mapped to the IP address for the detected host device 20(1) as determined in step 302, or a generated unique identifier for the detected host device 20(1), in order to facilitate vulnerability scanning, for example. In particular, the network assessment device 14 can utilize the host inventory database 44 to identify the host devices 20(1)-20(n) that require a vulnerability scan or other security check. Accordingly, the host inventory database 44 advantageously includes entries for each host device 20(1)-20(n) in the network environment 10, including those host devices 20(2)-20(n) coupled directly to the internal communication network 18, and having entries that include a MAC/IP address mapping, and the host device 20(1) coupled to a network segment (e.g., via VPN connection 26), and having an entry with an IP address or unique identifier mapped to a set of identifiable information obtained in iteration(s) of step 306.

Subsequent to updating the host inventory database 44, the network scanning device 12 proceeds back to step 300 and may update the machine learning model 46. The updating of the machine learning model 46 can be based on the particular network characteristic(s) input to the machine learning model 46, the test(s) applied for the detected host, the obtained results from the applied test(s), or other data useful for continued learning and optimization of the machine learning model 46 with respect to generation of a minimal set of test(s) for particular types of hosts that will yield results that will satisfy the classification threshold.

Accordingly, as illustrated and described by way of the examples herein, this technology advantageously is able to inventory host devices across network segments to further facilitate vulnerability scanning and without requiring agents deployed on the segments or the particular host devices. By utilizing network characteristic(s) and/or prior test result(s) to select, prioritize, and rank tests from the test database 42, the machine learning model 46 of this technology advantageously facilitates application of a more optimized subset of test(s) in order to improve further improve the speed with which hosts can be uniquely identified and inventoried.

This technology can be applied in networks ranging in size from relatively small, single subnet layouts to complex enterprise networks or the Internet at large. The ability to establish an effective, accurate inventory of connected hosts is critical, and could be an enhancement, to a number of security, service, and accounting applications including vulnerability scanning.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for inventorying network hosts, the method comprising:
identifying, by a network scanning device, at least one of a plurality of tests based on an application of a model to one or more characteristics of a network following detection of a host device in a segment of the network;
applying, by the network scanning device, the identified at least one of the plurality of tests on the detected host device to obtain at least one result comprising identifiable information for the detected host device;
determining, by the network scanning device, when a classification threshold has been satisfied for the detected host device based at least in part on the identifiable information; and
updating, by the network scanning device, a host inventory database to include at least the identifiable information, when the determination indicates the classification threshold has been satisfied.

2. The method of claim 1, further comprising ranking, by the network scanning device, a subset of the plurality of tests based on the one or more characteristics of the network to identify the at least one of the plurality of tests.

3. The method of claim 1, further comprising identifying, by the network scanning device, the at least one of the plurality of tests based at least in part on a protocol used by the host device to provide a service or to communicate with another host device.

4. The method of claim 1, wherein the model comprises a machine learning model and the method further comprises updating, by the network scanning device, the machine learning model based on one or more of the one or more characteristics of the network, the identified at least one of the plurality of tests, or the identifiable information.

5. The method of claim 1, further comprising:
generating, by the network scanning device, a unique identifier for the detected host device; and
storing, by the network scanning device, the generated unique identifier in an entry of the host inventory database along with the identifiable information to facilitate subsequent vulnerability scanning of the detected host device.

6. The method of claim 1, further comprising repeating, by the network scanning device, the identification and application of the at least one of the plurality of tests based at least in part on the obtained at least one result, when the determination indicates the classification threshold has not been satisfied.

7. A network scanning device, comprising memory comprising programmed instructions stored thereon and one or more processors configured to execute the stored programmed instructions to:
identify at least one of a plurality of tests based on an application of a model to one or more characteristics of a network following detection of a host device in a segment of the network;
apply the identified at least one of the plurality of tests on the detected host device to obtain at least one result comprising identifiable information for the detected host device;
determine when a classification threshold has been satisfied for the detected host device based at least in part on the identifiable information; and
update a host inventory database to include at least the identifiable information, when the determination indicates the classification threshold has been satisfied.

8. The network scanning device of claim 7, wherein the one or more processors are further configured to execute the stored programmed instructions to rank a subset of the plurality of tests based on the one or more characteristics of the network to identify the at least one of the plurality of tests.

9. The network scanning device of claim 7, wherein the one or more processors are further configured to execute the stored programmed instructions to identify the at least one of the plurality of tests based at least in part on a protocol used by the host device to provide a service or to communicate with another host device.

10. The network scanning device of claim 7, wherein the model comprises a machine learning model and the one or more processors are further configured to execute the stored programmed instructions to update the machine learning model based on one or more of the one or more characteristics of the network, the identified at least one of the plurality of tests, or the identifiable information.

11. The network scanning device of claim 7, wherein the one or more processors are further configured to execute the stored programmed instructions to:
generate a unique identifier for the detected host device; and
store the generated unique identifier in an entry of the host inventory database along with the identifiable information to facilitate subsequent vulnerability scanning of the detected host device.

12. The network scanning device of claim 7, wherein the one or more processors are further configured to execute the stored programmed instructions to repeat the identification and application of the at least one of the plurality of tests based at least in part on the obtained at least one result, when the determination indicates the classification threshold has not been satisfied.

13. A non-transitory machine readable medium having stored thereon instructions for inventorying network hosts comprising executable code that, when executed by one or more processors, causes processors to:
identify at least one of a plurality of tests based on an application of a model to one or more characteristics of a network following detection of a host device in a segment of the network;
apply the identified at least one of the plurality of tests on the detected host device to obtain at least one result comprising identifiable information for the detected host device;
determine when a classification threshold has been satisfied for the detected host device based at least in part on the identifiable information; and
update a host inventory database to include at least the identifiable information, when the determination indicates the classification threshold has been satisfied.

14. The non-transitory machine readable medium of claim 13, wherein the executable code, when executed by the one or more processors, further causes the one or more processors to rank a subset of the plurality of tests based on the one or more characteristics of the network to identify the at least one of the plurality of tests.

15. The non-transitory machine readable medium of claim 13, wherein the executable code, when executed by the one or more processors, further causes the one or more processors to identify the at least one of the plurality of tests based at least in part on a protocol used by the host device to provide a service or to communicate with another host device.

16. The non-transitory machine readable medium of claim 13, wherein the model comprises a machine learning model and the executable code, when executed by the one or more processors, further causes the one or more processors to update the machine learning model based on one or more of the one or more characteristics of the network, the identified at least one of the plurality of tests, or the identifiable information.

17. The non-transitory machine readable medium of claim 13, wherein the executable code, when executed by the one or more processors, further causes the one or more processors to:
generate a unique identifier for the detected host device; and
store the generated unique identifier in an entry of the host inventory database along with the identifiable information, to facilitate subsequent vulnerability scanning of the detected host device.

18. The non-transitory machine readable medium of claim 13, wherein the executable code, when executed by the one or more processors, further causes the one or more processors to repeat the identification and application of the at least one of the plurality of tests based at least in part on the obtained at least one result, when the determination indicates the classification threshold has not been satisfied.
